(19) United States
(12) Patent Application Publication
(10) Pub. No.: US 2023/0243775 A1
(43) Pub. Date: Aug. 3, 2023

(54) GAS SENSOR ELEMENT

(71) Applicant: NGK Insulators, Ltd., Nagoya-shi (JP)

(72) Inventors: Yusuke WATANABE, Nagoya-shi (JP); Shotaro NIIZUMA, Nagoya-shi (JP); Toshihiro HIRAKAWA, Nagoya-shi (JP)

(21) Appl. No.: 18/102,796

(22) Filed: Jan. 30, 2023

(30) Foreign Application Priority Data
Feb. 1, 2022 (JP) 2022-014250

(51) Int. Cl. G01N 27/407

(52) U.S. Cl. CPC G01N 27/4077; G01N 27/4071

(57) ABSTRACT

A gas sensor element capable of preventing a decrease in responsiveness despite a protective layer covering a gas introduction opening is provided. A gas sensor element according to an aspect of the present invention includes an element base having a surface in which a gas introduction opening is open, a protective layer, a buffer layer, and a gas introduction layer that is disposed between the element base and the buffer layer. The gas introduction layer covers the gas introduction opening, is in contact with the protective layer, and has a porosity that is 30% or more and is higher by 5% or more than the porosity of the buffer layer.

### CROSS-REFERENCE TO RELATED APPLICATION

The present application claims priority from Japanese application JP 2022-14250, filed on Feb. 1, 2022, the contents of which is hereby incorporated by reference into this application.

### TECHNICAL FIELD

The present invention relates to a gas sensor element.

### BACKGROUND ART

A conventionally-known gas sensor element includes a protective layer and an element base having a solid electrolyte, and a buffer layer having a porosity lower than that of the protective layer is disposed between the element base and the protective layer in order to prevent the protective layer from peeling away from the element base (JP 2021-156729A).

JP 2021-156729A is an example of related art.

### SUMMARY OF THE INVENTION

The inventors of the present invention found that conventional gas sensor elements having a structure as described above have the following problems. Specifically, in general, a target gas flow portion for the introduction of and allowing the passage of a measurement target gas is provided inside the element base, and a gas introduction opening serving as an entrance to the target gas flow portion is open in the surface (e.g., at least one of the leading end face and the side face) of the element base. The inventors of the present invention found that, if the buffer layer blocks the gas introduction opening, the measurement target gas may be insufficiently introduced into the target gas flow portion or it may take a long time to sufficiently introduce the measurement target gas into the target gas flow portion as a result of the buffer layer having a porosity lower than that of the protective layer, which leads to the problem of deterioration in the responsiveness of the gas sensor element.

Also, the inventors of the present invention found that it is difficult to provide the protective layer so as not to cover the gas introduction opening, and providing the protective layer so as not to cover the gas introduction opening may lead to a problem where the protective layer cannot sufficiently exhibit its effects.

The present invention has been made in view of such circumstances, and an object of one aspect of the present invention is to provide a gas sensor element capable of preventing a decrease in responsiveness despite the protective layer covering the gas introduction opening.

In order to solve the above-described problems, the following configurations are employed in the present invention.

A gas sensor element according to an aspect of the present invention includes: an element base having a surface in which a gas introduction opening is open, a measurement target gas being introduced into an internal space through the gas introduction opening; a protective layer that covers at least a face of the element base in which the gas introduction opening is open; a buffer layer that is disposed between the element base and the protective layer; and a gas introduction layer that is disposed between the element base and the buffer layer. A portion of the buffer layer is in contact with both the element base and the protective layer on the face of the element base in which the gas introduction opening is open, and the buffer layer has a porosity lower than that of the protective layer. The gas introduction layer covers at least a portion of the gas introduction opening, is in contact with the protective layer, and has a porosity that is 30% or more and is higher by 5% or more than a porosity of the buffer layer.

In this configuration, the buffer layer prevents the protective layer from peeling away from the element base, and the gas introduction layer reliably serves as a flow path through which the measurement target gas is guided from the protective layer to the gas introduction opening. Accordingly, with the gas sensor element according to the above aspect of the present invention, a decrease in responsiveness can be prevented due to the gas introduction layer that reliably serves as a flow path through which the measurement target gas is guided from the protective layer to the gas introduction opening despite the protective layer covering the gas introduction opening.

In the gas sensor element according to the above aspect, the gas introduction layer may have an area that is 0.2 to 0.8 times as large as an area of the face of the element base in which the gas introduction opening is open. With this configuration, the gas introduction layer having an area that is 0.2 to 0.8 times as large as the area of the face of the element base in which the gas introduction opening is open can necessarily and sufficiently serve as a flow path through which the measurement target gas is guided from the protective layer to the gas introduction opening.

In the gas sensor element according to the above aspect, the gas introduction layer may have a porosity of 45% or more and 60% or less. With this configuration, the gas introduction layer having a porosity of 45% or more and 60% or less can necessarily and sufficiently serve as a flow path through which the measurement target gas is guided from the protective layer to the gas introduction opening.

In the gas sensor element according to the above aspect, the gas introduction layer may be in contact with the protective layer at at least an edge closest to the gas introduction opening out of edges that surround the face of the element base in which the gas introduction opening is open. With this configuration, the gas introduction layer through which the measurement target gas is guided from the protective layer to the gas introduction opening is in contact with the protective layer at at least the edge closest to the gas introduction opening out of the edges that surround the face of the element base in which the gas introduction opening is open. That is to say, as a flow path through which the measurement target gas is guided from the protective layer to the gas introduction opening, the gas introduction layer connects at least the gas introduction opening and the protective layer at the shortest distance. Accordingly, a necessary and sufficient amount of the measurement target gas can be guided from the protective layer to the gas introduction opening through the gas introduction layer.

In the gas sensor element according to the above aspect, the gas introduction layer may cover the entire gas introduction opening on the face of the element base in which the gas introduction opening is open, and further extend from the gas introduction opening toward an edge opposed to an edge closest to the gas introduction opening out of edges that surround the face of the element base in which the gas introduction opening is open.

With this configuration, the gas introduction layer covers the entire gas introduction opening, and further extends from the gas introduction opening toward the edge opposed to the edge closest to the gas introduction opening out of the edges that surround the face of the element base in which the gas introduction opening is open. Accordingly, the gas introduction layer can prevent foreign matter, poisonous substances, and the like from entering the inner space via the gas introduction opening. Also, foreign matter, poisonous substances, and the like are more likely to accumulate in a portion of the gas introduction layer that extends toward the edge opposed to the edge closest to the gas introduction opening than in a portion of the gas introduction layer on the gas introduction opening, thus making it possible to protect the gas sensor from the adverse effects induced by foreign matter, poisonous substances, and the like.

In the gas sensor element according to the above aspect, a portion of the gas introduction layer may extend from the gas introduction opening to the internal space. With this configuration, a portion of the gas introduction layer extends from the gas introduction opening into the internal space. Accordingly, the gas introduction layer can prevent foreign matter, poisonous substances, and the like from entering the inner space via the gas introduction opening.

With the present invention, it is possible to provide a gas sensor element capable of preventing a decrease in responsiveness despite the protective layer covering the gas introduction opening.

### BRIEF DESCRIPTION OF THE DRAWINGS

FIG. 1 is a schematic cross-sectional view schematically showing an example of the configuration of a sensor element according to an embodiment.

FIG. 2 is a schematic cross-sectional view showing an example of the configuration of an element base included in the sensor element shown in FIG. 1.

FIG. 3 is a diagram showing an example of a cross section of the sensor element shown in FIG. 1 taken along line II-II and viewed in the direction of the arrows.

FIG. 4 is a diagram showing an example of a cross section of a sensor element according to a modified example viewed in the direction of the arrows in the same manner as in FIG. 3. In this example, the area of the gas introduction layer is 0.2 times as large as the area of the leading end face.

FIG. 5 is a diagram showing an example of a cross section of a sensor element according to a modified example viewed in the direction of the arrows in the same manner as in FIG. 4. In this example, the area of the gas introduction layer is 0.8 times as large as the area of the leading end face.

FIG. 6 is a schematic cross-sectional view schematically showing an example of the configuration of a sensor element according to a modified example. In this example, a portion of the gas introduction layer shown in FIG. 1 extends to the inside of a target gas flow portion.

### EMBODIMENTS OF THE INVENTION

Hereinafter, an embodiment according to one aspect of the present invention (also referred to as “this embodiment” hereinafter) will be described with reference to the drawings. Note that this embodiment described below is merely illustrative of the present invention in all respects. It goes without saying that various improvements and modifications can be made without departing from the scope of the present invention. In other words, in implementation of the present invention, specific configurations suitable for embodiments may be employed as appropriate.

In a gas sensor element according to this embodiment, a face of an element base in which a gas introduction opening is open is covered by a protective layer for the purpose of, for example, improving water resistance (for example, the protective layer is provided on the outermost portion of the face of the element base in which the gas introduction opening is open). The protective layer is in contact with a buffer layer for preventing the protective layer from peeling away from the element base, and a gas introduction layer serving as a flow path through which a measurement target gas is guided from the protective layer to the gas introduction opening. The gas introduction layer has a porosity of 30% or more in order to allow a necessary and sufficient amount of measurement target gas to be guided from the protective layer to the gas introduction opening through the gas introduction layer. Also, the gas introduction layer has a porosity higher by 5% or more than the porosity of the buffer layer, so that a measurement target gas flows through the gas introduction layer rather than the buffer layer. The following describes an example of the gas sensor element having this configuration.

### CONFIGURATION EXAMPLE

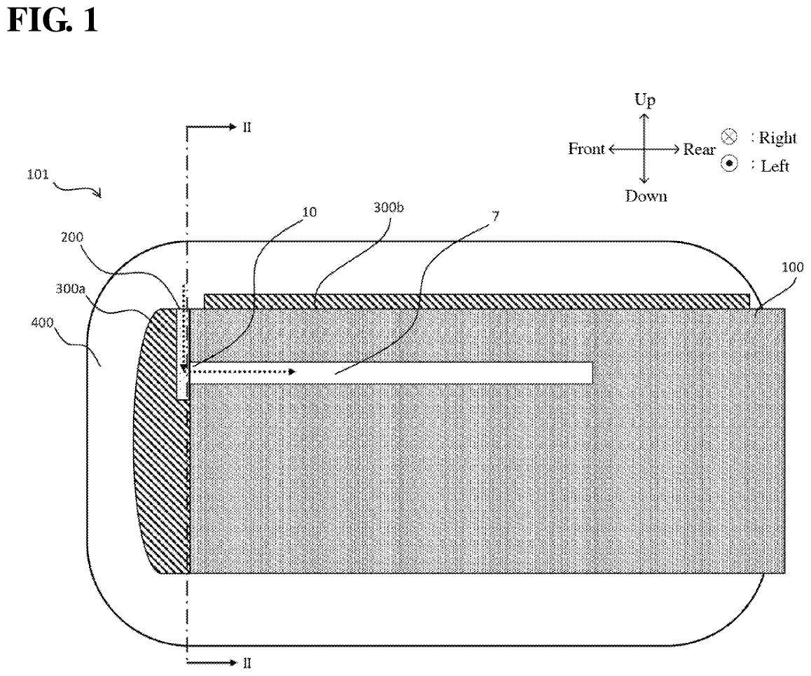

FIG. 1 is a schematic cross-sectional view schematically showing an example of the configuration of a gas sensor element 101 according to this embodiment. As illustrated in FIG. 1, the gas sensor element 101 includes an element base 100, a protective layer 400, a buffer layer 300, and a gas introduction layer 200. A gas introduction opening 10 is open in the surface of the element base 100, and a measurement target gas is introduced into a target gas flow portion 7 formed by the internal space of the element base through the gas introduction opening 10. In the example shown in FIG. 1, the gas introduction opening 10 is open in the front-side (leading-end-side) surface of the element base 100. In the following description, the front-side (leading-end-side) surface of the element base 100 may also be referred to as a “leading end face” of the element base 100. The protective layer 400 covers at least the face of the element base 100 in which the gas introduction opening 10 is open (the leading end face of the element base 100 in the example shown in FIG. 1). The buffer layer 300 has a porosity lower than that of the protective layer 400, and a portion thereof is in contact with both the element base 100 and the protective layer 400 on the face of the element base 100 in which the gas introduction opening 10 is open. The gas introduction layer 200 is disposed between the element base 100 and the buffer layer 300, covers at least a portion of the gas introduction opening 10, and is in contact with the protective layer 400. The gas introduction layer 200 has a porosity that is 30% or more and is higher by 5%- or more than the porosity of the buffer layer 300. The element base 100, the protective layer 400, the buffer layer 300, and the gas introduction layer 200 are described below in detail.

### Element Base

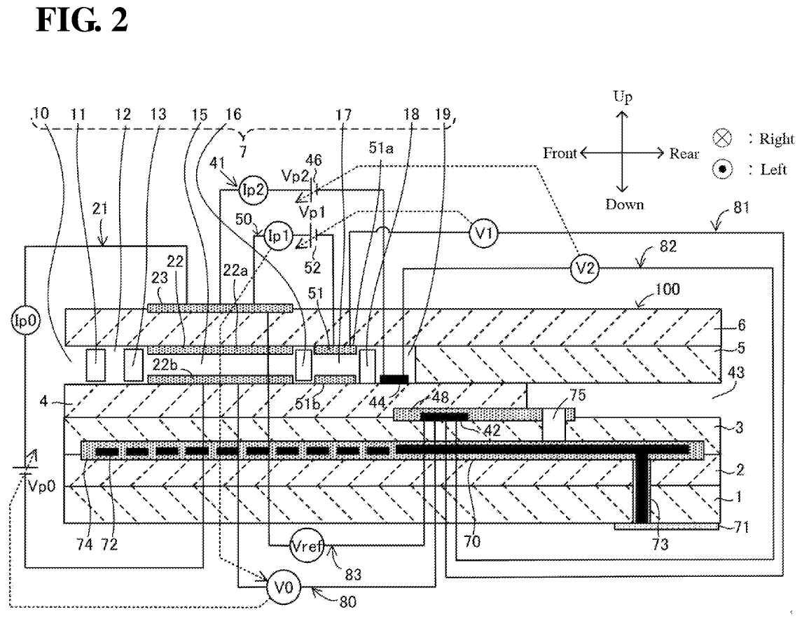

FIG. 2 is a schematic cross-sectional view schematically showing an example of the configuration of the element base 100 included in the gas sensor element 101. The element base 100 is shaped as an elongated plate-like body that extends along a lengthwise direction (axial direction) of the gas sensor element 101, for example, and has a rectangular parallelepiped shape, for example. The element base 100 illustrated in FIG. 2 includes a leading end portion and a rear end portion serving as end portions in the lengthwise direction, and, in the following description, the leading end portion is the left end portion (i.e., the front-side end portion) in FIG. 2 and the rear end portion is the right end portion (i.e., the rear-side end portion) in FIG. 2. However, the shape of the element base 100 does not necessarily need to be limited to such an example, and may be appropriately selected in accordance with the mode of implementation. Note that, in the following description, the far side relative to the paper surface in FIG. 2 is the right side of the element base 100, and the near side relative to the paper surface is the left side of the element base 100.

As illustrated in FIG. 2, the element base 100 includes a laminate constituted by a first substrate layer 1, a second substrate layer 2, a third substrate layer 3, a first solid electrolyte layer 4, a spacer layer 5, and a second solid electrolyte layer 6 that are stacked in this order from the lower side. These layers 1 to 6 are each constituted by an oxygen-ion-conductive solid electrolyte layer made of zirconia (ZrO₂) or the like. The solid electrolytes forming the layers 1 to 6 may be dense. Here, being “dense” means having a porosity of 5% or less.

The element base 100 is manufactured by, for example, performing steps such as predetermined processing and printing of wiring patterns on ceramic green sheets corresponding to the respective layers, stacking the resultant layers, and then integrating them through firing. In one example, the element base 100 is a laminate constituted by a plurality of ceramic layers. In this embodiment, the upper face of the second solid electrolyte layer 6 forms the upper face of the element base 100, the lower face of the first substrate layer 1 forms the lower face of the element base 100, and side faces of the layers 1 to 6 form side faces of the element base 100.

In this embodiment, an internal space configured to receive a measurement target gas from an external space is provided between the lower face of the second solid electrolyte layer 6 and the upper face of the first solid electrolyte layer 4, at the leading end portion of the element base 100. The internal space according to this embodiment is configured such that the gas introduction opening 10, a first diffusion control portion 11, a buffer space 12, a second diffusion control portion 13, a first internal cavity 15, a third diffusion control portion 16, a second internal cavity 17, a fourth diffusion control portion 18, and a third internal cavity 19 are arranged adjacent to each other in this order in a connected manner. In other words, the internal space according to this embodiment has a three-cavity structure (the first internal cavity 15, the second internal cavity 17, and the third internal cavity 19).

In one example, this internal space is formed by cutting out a portion of the spacer layer 5. The upper portion of the internal space is defined by the lower face of the second solid electrolyte layer 6. The lower portion of the internal space is defined by the upper face of the first solid electrolyte layer 4. The side portions of the internal space are defined by the side faces of the spacer layer 5.

The first diffusion control portion 11 is provided as two laterally elongated slits (the long sides of the openings thereof extend along a direction perpendicular to the plane of FIG. 2). Also, the second diffusion control portion 13, the third diffusion control portion 16, and the fourth diffusion control portion 18 are provided as holes whose lengths along a direction perpendicular to the plane of FIG. 2 are shorter than the first internal cavity 15, the second internal cavity 17, and the third internal cavity 19, respectively.

As illustrated in FIG. 2, the second diffusion control portion 13 and the third diffusion control portion 16 may each be provided as two laterally elongated slits (the long sides of the openings thereof extend along a direction perpendicular to the plane of FIG. 2), similarly to the first diffusion control portion 11. On the other hand, the fourth diffusion control portion 18 may be provided as one laterally elongated slit (the lengthwise direction of the opening thereof extends along a direction perpendicular to the plane of FIG. 2) formed as a gap defined on one side by the lower face of the second solid electrolyte layer 6. In other words, the fourth diffusion control portion 18 may be in contact with the upper face of the first solid electrolyte layer 4. The second diffusion control portion 13, the third diffusion control portion 16, and the fourth diffusion control portion 18 will each be described in detail later. A portion (internal space) extending from the gas introduction opening 10 to the third internal cavity 19 will be referred to as the target gas flow portion 7.

A reference gas introduction space 43 having side portions defined by side faces of the first solid electrolyte layer 4 is provided between the upper face of the third substrate layer 3 and the lower face of the spacer layer 5, at a position that is far from the leading end side (front side of the element base 100) relative to the target gas flow portion 7. A reference gas such as air is introduced into the reference gas introduction space 43. Note that the configuration of the element base 100 is not necessarily limited to such an example. In another example, the first solid electrolyte layer 4 may be configured to extend to the rear end of the element base 100, and the reference gas introduction space 43 may be omitted. In this case, an air introduction layer 48 may be configured to extend to the rear end of the element base 100.

An air introduction layer 48 is provided on a portion of the upper face of the third substrate layer 3 adjacent to the reference gas introduction space 43. The air introduction layer 48 is a layer made of porous alumina and is configured such that a reference gas is introduced thereto via the reference gas introduction space 43. In addition, the air introduction layer 48 is formed so as to cover a reference electrode 42.

The reference electrode 42 is formed so as to be held between the first solid electrolyte layer 4 and the upper face of the third substrate layer 3, and is surrounded by the air introduction layer 48 that is connected to the reference gas introduction space 43. The reference electrode 42 is used to measure the oxygen concentration (oxygen partial pressure) in the first internal cavity 15 and the second internal cavity 17. This will be described in detail below.

The gas introduction opening 10 is a portion of the target gas flow portion 7 that is open to the external space. A configuration is employed in which a measurement target gas is introduced into the element base 100 from the external space through the gas introduction opening 10. In this embodiment, as illustrated in FIG. 2, the gas introduction opening 10 is located in the leading end face (front face) of the element base 100. In other words, the target gas flow portion 7 is configured to have an opening in the leading end face of the element base 100. However, it is not essential that the target gas flow portion 7 is configured to have an opening in the leading end face of the element base 100, or in other words, that the gas introduction opening 10 is located in the leading end face of the element base 100. The element base 100 need only be configured such that a measurement target gas can be introduced into the target gas flow portion 7 from the external space, and the gas introduction opening 10 may be located in the right side face or the left side face of the element base 100, for example.

The first diffusion control portion 11 is a region that applies predetermined diffusion resistance to the measurement target gas introduced through the gas introduction opening 10.

The buffer space 12 is a space that is provided in order to guide the measurement target gas, introduced from the first diffusion control portion 11, to the second diffusion control portion 13.

The second diffusion control portion 13 is a region that applies predetermined diffusion resistance to the measurement target gas that is to be introduced from the buffer space 12 into the first internal cavity 15.

When the measurement target gas is introduced into the first internal cavity 15 from the exterior space of the element base 100, the measurement target gas may be rapidly introduced into the gas sensor element 100 through the gas introduction opening 10 due to a change in the pressure of the measurement target gas in the external space (a pulsation of exhaust pressure in the case where the measurement target gas is exhaust gas of an automobile). Even in this case, with this configuration, the introduced measurement target gas is not directly introduced into the first internal cavity 15, but rather is introduced into the first internal cavity 15 after passing through the first diffusion control portion 11, the buffer space 12, and the second diffusion control portion 13 where fluctuation in the concentration of the measurement target gas is canceled out. Accordingly, fluctuation in the concentration of the measurement target gas introduced into the first internal cavity 15 is reduced to a mostly negligible amount.

The first internal cavity 15 is provided as a space for adjusting the oxygen partial pressure in the measurement target gas introduced via the second diffusion control portion 13. The oxygen partial pressure is adjusted by operation of a main pump cell 21.

The main pump cell 21 is an electro-chemical pump cell constituted by an internal pump electrode 22, an external pump electrode 23, and the second solid electrolyte layer 6 held between these electrodes. The internal pump electrode 22 has a ceiling electrode portion 22a provided over substantially the entire lower face of the second solid electrolyte layer 6 adjacent to (facing) the first internal cavity 15. The external pump electrode 23 is provided so as to be adjacent to the external space in a region corresponding to the ceiling electrode portion 22a, on the upper face of the second solid electrolyte layer 6.

The internal pump electrode 22 is formed so as to extend across the upper and lower solid electrolyte layers that define the first internal cavity 15 (i.e., the second solid electrolyte layer 6 and the first solid electrolyte layer 4), and the spacer layer 5 that forms side walls of the first internal cavity 15. Specifically, the ceiling electrode portion 22a is formed on the lower face of the second solid electrolyte layer 6 that forms the ceiling face of the first internal cavity 15, and a bottom electrode portion 22b is formed on the upper face of the first solid electrolyte layer 4 that forms the bottom face of the first internal cavity 15. Side electrode portions (not illustrated) that connect the ceiling electrode portion 22a and the bottom electrode portion 22b are formed on side wall faces (inner faces) of the spacer layer 5 that forms the two side wall portions of the first internal cavity 15. In other words, the internal pump electrode 22 is provided in the form of a tunnel at the region where the side electrode portions are disposed.

The internal pump electrode 22 and the external pump electrode 23 are formed as porous cermet electrodes (e.g., cermet electrodes formed using ZrO₂ and Pt containing 1% Au). Note that the internal pump electrode 22, which comes into contact with the measurement target gas, is made of a material that has a reduced capacity for reducing a nitrogen oxide (NOₓ) component in the measurement target gas.

The element base 100 is configured such that the main pump cell 21 can apply a desired pump voltage Vp0 between/across? the internal pump electrode 22 and the external pump electrode 23, thereby causing a pump current Ip0 to flow in the positive direction or the negative direction between the internal pump electrode 22 and the external pump electrode 23, so that oxygen in the first internal cavity 15 is pumped out to the external space, or oxygen in the external space is pumped into the first internal cavity 15.

Furthermore, an oxygen partial pressure detection sensor cell 80 for main pump control (i.e., an electro-chemical sensor cell) for detecting the oxygen concentration (oxygen partial pressure) in the atmosphere in the first internal cavity 15 is formed by the internal pump electrode 22, the second solid electrolyte layer 6, the spacer layer 5, the first solid electrolyte layer 4, the third substrate layer 3, and the reference electrode 42.

The element base 100 is configured to be capable of identifying the oxygen concentration (oxygen partial pressure) in the first internal cavity 15 by measuring an electromotive force V0 in the oxygen partial pressure detection sensor cell 80 for main pump control. Furthermore, the pump current Ip0 is controlled by performing feedback control on Vp0 such that the electromotive force V0 is kept constant. Accordingly, the oxygen concentration in the first internal cavity 15 can be kept at a predetermined constant value.

The third diffusion control portion 16 is a region that applies predetermined diffusion resistance to the measurement target gas whose oxygen concentration (oxygen partial pressure) in the first internal cavity 15 has been controlled through operation of the main pump cell 21, thereby guiding the measurement target gas to the second internal cavity 17.

The second internal cavity 17 is provided as a space for further adjusting the oxygen partial pressure in the measurement target gas introduced via the third diffusion control portion 16. The oxygen partial pressure is adjusted by operation of an auxiliary pump cell 50.

The auxiliary pump cell 50 is an auxiliary electro-chemical pump cell constituted by an auxiliary pump electrode 51, the external pump electrode 23 (which is not limited to the external pump electrode 23, and may be any appropriate electrode on the outside of the element base 100), and the second solid electrolyte layer 6. The auxiliary pump electrode 51 has a ceiling electrode portion 51a provided on substantially the entirety of the lower face of the second solid electrolyte layer 6 facing the second internal cavity 17.

The auxiliary pump electrode 51 with this configuration is disposed inside the second internal cavity 17 in the form of a tunnel similarly to the above-described internal pump electrode 22 provided inside the first internal cavity 15. That is to say, the ceiling electrode portion 51a is formed on the lower face of the second solid electrolyte layer 6 that forms the ceiling face of the second internal cavity 17, and a bottom electrode portion 51b is formed on the upper face of the first solid electrolyte layer 4 that forms the bottom face of the second internal cavity 17. Side electrode portions (not illustrated) that connect the ceiling electrode portion 51a and the bottom electrode portion 51b are formed on two wall faces of the spacer layer 5 that form side walls of the second internal cavity 17. Thus, the auxiliary pump electrode 51 has a structure in the form of a tunnel.

The auxiliary pump electrode 51 is also made of a material that has a reduced capacity for reducing a nitrogen oxide component in the measurement target gas, similarly to the internal pump electrode 22.

The element base 100 is configured such that the auxiliary pump cell 50 can apply a desired voltage Vp1 between/across? the auxiliary pump electrode 51 and the external pump electrode 23, so that oxygen in the atmosphere in the second internal cavity 17 is pumped out to the external space, or oxygen is pumped from the external space into the second internal cavity 17.

Furthermore, an oxygen partial pressure detection sensor cell 81 for auxiliary pump control (i.e., an electro-chemical sensor cell) for controlling the oxygen partial pressure in the atmosphere in the second internal cavity 17 is formed by the auxiliary pump electrode 51, the reference electrode 42, the second solid electrolyte layer 6, the spacer layer 5, the first solid electrolyte layer 4, and the third substrate layer 3.

The auxiliary pump cell 50 performs pumping using a variable power source 52 whose voltage is controlled based on an electromotive force V1 detected by the oxygen partial pressure detection sensor cell 81 for auxiliary pump control. Accordingly, the oxygen partial pressure in the atmosphere in the second internal cavity 17 is controlled to be a partial pressure that is low enough to have substantially no impact on the NOₓ measurement.

Furthermore, a pump current Ip1 is used to control the electromotive force of the oxygen partial pressure detection sensor cell 80 for main pump control. Specifically, the pump current Ip1 is input as a control signal to the oxygen partial pressure detection sensor cell 80 for main pump control, and the electromotive force V0 is controlled so as to keep a constant gradient of the oxygen partial pressure in the measurement target gas that is introduced into the second internal cavity 17 from the third diffusion control portion 16. In the case where the sensor is used as an NOₓ sensor, the oxygen concentration in the second internal cavity 17 is kept at a constant value of around 0.001 ppm through operation of the main pump cell 21 and the auxiliary pump cell 50.

The fourth diffusion control portion 18 is a region that applies predetermined diffusion resistance to the measurement target gas whose oxygen concentration (oxygen partial pressure) has been controlled through operation of the auxiliary pump cell 50 in the second internal cavity 17, thereby guiding the measurement target gas to the third internal cavity 19.

The third internal cavity 19 is provided as a space for performing processing regarding measurement of the concentration of nitrogen oxide (NOₓ) in the measurement target gas introduced via the fourth diffusion control portion 18. The measurement of the NOₓ concentration is performed by operation of a measurement pump cell 41. In this embodiment, the measurement target gas, which was subjected to adjustment of the oxygen concentration (oxygen partial pressure) in advance in the first internal cavity 15 and then introduced via the third diffusion control portion, is further subjected to adjustment of the oxygen partial pressure by the auxiliary pump cell 50, in the second internal cavity 17. Accordingly, the oxygen concentration in the measurement target gas introduced into the third internal cavity 19 from the second internal cavity 17 can be precisely kept at a constant value. Therefore, the NOₓ concentration can be accurately measured in the element base 100 according to this embodiment.

The measurement pump cell 41 is used to measure the nitrogen oxide concentration in the measurement target gas in the third internal cavity 19. The measurement pump cell 41 is an electro-chemical pump cell constituted by a measurement electrode 44, the external pump electrode 23, the second solid electrolyte layer 6, the spacer layer 5, and the first solid electrolyte layer 4. In the example shown in FIG. 2, the measurement electrode 44 is provided on the upper face of the first solid electrolyte layer 4 adjacent to (facing) the third internal cavity 19.

The measurement electrode 44 is a porous cermet electrode. The measurement electrode 44 also functions as an NOₓ reduction catalyst for reducing NOₓ that is present in the atmosphere in the third internal cavity 19. In the example shown in FIG. 2, the measurement electrode 44 is exposed in the third internal cavity 19. In another example, the measurement electrode 44 may be covered by a diffusion control portion. The diffusion control portion may be constituted by a porous film containing alumina (Al₂O₃) as a main component. The diffusion control portion serves to restrict the amount of NOₓ flowing into the measurement electrode 44, and also functions as a protective film for the measurement electrode 44.

The element base 100 is configured such that the measurement pump cell 41 can pump out oxygen generated through decomposition of nitrogen oxide in the atmosphere around the measurement electrode 44, and can detect the amount of generated oxygen as a pump current Ip2.

Furthermore, in order to detect the oxygen partial pressure around the measurement electrode 44, the second solid electrolyte layer 6, the spacer layer 5, the first solid electrolyte layer 4, the third substrate layer 3, the measurement electrode 44, and the reference electrode 42 constitute an oxygen partial pressure detection sensor cell 82 for measurement pump control (i.e., an electro-chemical sensor cell). A variable power source 46 is controlled based on a voltage (an electromotive force) V2 detected by the oxygen partial pressure detection sensor cell 82 for measurement pump control.

The measurement target gas guided into the third internal cavity 19 reaches the measurement electrode 44 in a state in which the oxygen partial pressure has been controlled. Nitrogen oxide in the measurement target gas around the measurement electrode 44 is reduced to generate oxygen (2NO→N₂+O₂). The generated oxygen is pumped by the measurement pump cell 41, and, at that time, a voltage Vp2 of the variable power source is controlled such that the control voltage V2 detected by the oxygen partial pressure detection sensor cell 82 for measurement pump control is kept constant. The amount of oxygen generated around the measurement electrode 44 is proportional to the concentration of nitrogen oxide in the measurement target gas, and thus, it is possible to calculate the concentration of nitrogen oxide in the measurement target gas using the pump current Ip2 in the measurement pump cell 41.

Furthermore, if the measurement electrode 44, the first solid electrolyte layer 4, the third substrate layer 3, and the reference electrode 42 are combined to constitute an oxygen partial pressure detection means serving as an electro-chemical sensor cell, it is possible to detect an electromotive force that corresponds to a difference between the amount of oxygen generated through reduction of an NOₓ component in the atmosphere around the measurement electrode 44 and the amount of oxygen contained in reference air. This enables the measurement of the concentration of the nitrogen oxide component in the measurement target gas.

Furthermore, the second solid electrolyte layer 6, the spacer layer 5, the first solid electrolyte layer 4, the third substrate layer 3, the external pump electrode 23, and the reference electrode 42 constitute an electro-chemical sensor cell 83. The element base 100 is configured to be capable of detecting the oxygen partial pressure in the measurement target gas outside the sensor, based on an electromotive force Vref obtained by the sensor cell 83.

In the element base 100 having the above-described configuration, when the main pump cell 21 and the auxiliary pump cell 50 operate, the measurement target gas whose oxygen partial pressure is always kept at a constant low value (a value that has no substantial impact on the NOₓ measurement) can be supplied to the measurement pump cell 41. Accordingly, the element base 100 is configured to be capable of identifying the nitrogen oxide concentration in the measurement target gas, based on the pump current Ip2 that flows when oxygen generated through reduction of NOₓ is pumped out by the measurement pump cell 41, substantially in proportion to the nitrogen oxide concentration in the measurement target gas.

Furthermore, in order to improve the oxygen ion conductivity of the solid electrolyte, the element base 100 includes a heater 70 that serves to adjust the temperature of the element base 100 through heating and heat retention. In the example shown in FIG. 2, the heater 70 includes a heater electrode 71, a heat generation unit 72, a lead portion 73, a heater insulating layer 74, and a pressure dispersing hole 75. The lead portion 73 may be provided in the form of a through hole.

In this embodiment, the heater 70 is disposed at a position that is closer to the lower face of the element base 100 than the upper face of the element base 100 in the thickness direction (vertical direction/stacking direction) of the element base 100. However, the positioning of the heater 70 does not have to be limited to such an example, and may be appropriately selected in accordance with the mode of implementation.

The heater electrode 71 is an electrode formed so as to be in contact with the lower face of the first substrate layer 1 (the lower face of the element base 100). When the heater electrode 71 is connected to an external power source, electricity can be supplied from the outside to the heater 70.

The heat generation unit 72 is an electrical resistor formed so as to be held between the second substrate layer 2 and the third substrate layer 3 from above and below. The heat generation unit 72 is connected to the heater electrode 71 via the lead portion 73, and, when electricity is supplied from the outside via the heater electrode 71, the heat generation unit 72 generates heat, thereby heating and maintaining the temperature of a solid electrolyte constituting the element base 100.

Furthermore, the heat generation unit 72 is embedded over the entire region from the first internal cavity 15 to the second internal cavity 17, and thus the entire element base 100 can be adjusted to a temperature at which the above-described solid electrolyte is activated.

The heater insulating layer 74 is an insulating layer constituted by an insulating member made of alumina or the like on upper and lower faces of the heat generation unit 72. The heater insulating layer 74 is formed in order to realize electrical insulation between the second substrate layer 2 and the heat generation unit 72, and electrical insulation between the third substrate layer 3 and the heat generation unit 72.

The pressure dispersing hole 75 is a hole that extends through the third substrate layer 3 and is connected to the reference gas introduction space 43, and is formed in order to mitigate an increase in internal pressure that accompanies an increase in the temperature in the heater insulating layer 74.

### Protective Layer

In the gas sensor element 101, the protective layer 400 covers at least the face of the element base 100 in which the gas introduction opening 10 is open. The protective layer 400 illustrated in FIG. 1 covers the end portion of the element base 100 that is provided with the gas introduction opening 10 through which the measurement target gas is introduced. Specifically, in a predetermined range on the front side (leading end side) of the element base 100, the protective layer 400 covers the face (leading end face) of the element base 100 in which the gas introduction opening 10 is open, and the four side faces of the element base 100.

The protective layer 400 is water resistant and is provided in order to mainly prevent what is known as water-induced breakage of the element base 100. The term “water-induced breakage” refers to a phenomenon in which the element base 100 breaks when waterdrops attach to the element base 100 in use (e.g., in the case where water vapor in exhaust gas condenses to waterdrops). Since the heater 70 heats the element base 100 to a high temperature, the attachment of waterdrops causes thermal shock. As a result, the gas sensor element 101, particularly the element base 100, may crack (i.e., the element base 100 may break).

Accordingly, the protective layer 400 need only be provided in a predetermined range extending from the end portion (e.g., leading end portion) to which waterdrops may attach, rather than the entire element base 100. The protective layer 400 may be formed in a range between the leading end and a position that is about 12 mm to 14 mm away from the leading end in the element lengthwise direction. In the gas sensor element 101 illustrated in FIG. 1, the protective layer 400 covers the entire leading end portion of the element base 100, and portions of the side faces (a predetermined range in the element lengthwise direction) of the element base 100. That is to say, in the gas sensor element 101 illustrated in FIG. 1, the protective layer 400 is provided on the leading end portion and the outermost peripheral portion in a predetermined range of the element base 100.

The protective layer 400 is constituted by a porous body, and may be constituted by a high-porosity porous body having a porosity of 30% to 60%. In particular, the porosity of the protective layer 400 is favorably about 15% to 60%. This is because such a configuration does not influence the ease of production, uniformity, and introduction of the measurement target gas into the element base 100 through the gas introduction opening 10. However, the porosity may also be out of this range as long as water-induced breakage is favorably suppressed and the responsiveness of the gas sensor element 101 is unaffected.

Although FIG. 1 illustrates the protective layer 400 having a single-layer structure, the protective layer 400 may be constituted by a plurality of layers, and may have, for example, a two-layer structure. In the case where the protective layer 400 has a single-layer structure, the protective layer 400 may be, for example, a porous layer made of alumina with a purity of 99.0% or more.

The protective layer 400 has a thickness of, for example, 200 μm or more and 1,800 μm or less. If the thickness is smaller than 200 μm, the strength of the protective layer 400 is not sufficiently ensured, and there is a risk that pores in the protective layer 400 will be continuous with one another and form a passage passing through the protective layer 400 through which water vapor in the measurement target gas will pass and reach the element base 100.

On the other hand, if the thickness of the protective layer 400 is greater than 1,800 μm, it is difficult for the measurement target gas to reach the gas introduction opening 10 through the protective layer 400, and the responsiveness of the gas sensor element 101 is impaired. Also, such a thick protective layer is disadvantageous from the viewpoint of cost.

### Buffer Layer

In the gas sensor element 101, the buffer layer 300 is disposed between the element base 100 and the protective layer 400, and a portion thereof is in contact with both the element base 100 and the protective layer 400 on the face of the element base 100 in which the gas introduction opening 10 is open. In the gas sensor element 101 illustrated in FIG. 1, the protective layer 400 is provided on the end portion (leading end portion) and the outermost peripheral portion in a predetermined range of the element base 100, and the buffer layer 300 is interposed between the element base 100 and the protective layer 400. Specifically, the buffer layer 300 illustrated in FIG. 1 includes a leading-end buffer layer 300a and a side-face buffer layer 300b. The leading-end buffer layer 300a is interposed between a portion of the protective layer 400 that covers the entire leading end portion (leading end face) of the element base 100, and the leading end portion (leading end face) of the element base 100. The side-face buffer layer 300b is interposed between a portion of the protective layer 400 that covers portions of the side faces (a predetermined range in the element lengthwise direction) of the element base 100, and the portions of the side faces of the element base 100.

The buffer layer 300 is less porous than the protective layer 400. In particular, it is desirable that the buffer layer 300 has a porosity of less than 30%. The inventors of the present invention carried out tests for responsiveness and water resistance, which will be described later, and found that a buffer layer 300 having a porosity of 30% or more did not function as the buffer layer 300 (such a buffer layer 300 is susceptible to damage). For example, the porosity of the buffer layer 300 is 10% to 20%.

The buffer layer 300 is provided mainly in order to prevent the protective layer 400 from peeling away from the element base 100. For example, the buffer layer 300 is provided in order to prevent peeling, breakage, etc. of the protective layer 400 caused by a difference in thermal expansion coefficient between alumina constituting the protective layer 400 and zirconia constituting the element base 100 while the gas sensor element 101 is in use. The buffer layer 300 ensures bonding (adhesion) to the protective layer 400 formed thereon.

In order to reduce a difference in thermal expansion between the element base 100 and the protective layer 400, it is sufficient that the buffer layer 300 is formed so as to correspond to the protective layer 400. In the gas sensor element 101 illustrated in FIG. 1, the leading-end buffer layer 300a is formed so as to correspond to the portion of the protective layer 400 that covers the entire leading end portion of the element base 100, and cover at least a portion of the leading end portion (leading end face) of the element base 100. Also, the side-face buffer layer 300b is formed so as to correspond to the portion of the protective layer 400 that covers portions of the side faces of the element base 100, and cover the portions of the side faces of the element base 100. Note that the buffer layer 300 may be provided, for example, in a range on the surface of the element base 100 that is slightly larger than the range in which the protective layer 400 is present.

### Gas Introduction Layer 200

In the gas sensor element 101, the gas introduction layer 200 is disposed between the element base 100 and the buffer layer 300, covers at least a portion of the gas introduction opening 10, and is in contact with the protective layer 400. The gas introduction layer 200 is a flow path for guiding the measurement target gas from the protective layer 400 to the gas introduction opening 10 of the element base 100, and in other words, the gas introduction layer 200 is a flow path for guiding the measurement target gas from the protective layer 400 into the element base 100 (specifically, the target gas flow portion 7).

The gas introduction layer 200 is in contact with the protective layer 400. In the gas sensor element 101 illustrated in FIG. 1, the gas introduction layer 200 is in contact with the protective layer 400 at the upper edge (on the upper edge side) of the leading end face of the element base 100.

In the gas sensor element 101 illustrated in FIG. 1, the gas introduction opening 10 is provided in the upper portion of the face (the leading end face in the example shown in FIG. 1) of the element base 100 in which the gas introduction opening 10 is open. Accordingly, the edge closest to the gas introduction opening 10 out of the edges that surround the face (leading end face) of the element base 100 in which the gas introduction opening 10 is open is the upper edge of the leading end face. Therefore, the gas introduction layer 200 illustrated in FIG. 1 is in contact with the protective layer 400 at the edge closest to the gas introduction opening 10 out of the edges that surround the face of the element base 100 in which the gas introduction opening 10 is open.

The gas sensor element 101 has a configuration in which the gas introduction layer 200 is in contact with the protective layer 400 at the edge closest to the gas introduction opening 10 out of the edges that surround the face of the element base 100 in which the gas introduction opening 10 is open, and thus exhibits the following effects. That is to say, in the gas sensor element 101 having the above-described configuration, the gas introduction layer 200 connects at least the protective layer 400 and the gas introduction opening 10 at the shortest distance, the gas introduction layer 200 serving as a flow path through which the measurement target gas is guided from the protective layer 400 to the gas introduction opening 10. Accordingly, a necessary and sufficient amount of the measurement target gas can be guided from the protective layer 400 to the gas introduction opening 10 through the gas introduction layer 200.

However, it is not essential that the gas introduction layer 200 be in contact with the protective layer 400 at the edge closest to the gas introduction opening 10 out of the edges that surround the face of the element base 100 in which the gas introduction opening 10 is open. As described above, the gas sensor element 101 need only have a configuration in which the gas introduction layer 200 can reliably serve as a flow path through which the measurement target gas is guided from the protective layer 400 to the gas introduction opening 10, and the gas introduction layer 200 need only be in contact with the protective layer 400 while covering at least a portion of the gas introduction opening 10. There is no particular limitation on the position at which the gas introduction layer 200 is in contact with the protective layer 400.

On the face (the leading end face in the example shown in FIG. 1) of the element base 100 in which the gas introduction opening 10 is open, the gas introduction layer 200 illustrated in FIG. 1 covers the entire gas introduction opening 10 and further extends downward from the gas introduction opening 10. Specifically, the gas introduction layer 200 extends from the gas introduction opening 10 toward the edge (the lower edge in the example shown in FIG. 1) opposed to the edge (the upper edge in the example shown in FIG. 1) closest to the gas introduction opening 10 out of the edges that surround the face of the element base 100 in which the gas introduction opening 10 is open.

The gas sensor element 101 has a configuration in which, on the face of the element base 100 in which the gas introduction opening 10 is open, the gas introduction layer 200 covers the entire gas introduction opening 10 and further extends downward from the gas introduction opening 10, and thus exhibits the following effects. That is to say, in the gas sensor element 101 having the above-described configuration, the gas introduction layer 200 can prevent foreign matter, poisonous substances, and the like from entering the element base 100 (specifically, the target gas flow portion 7) via the gas introduction opening 10.

Also, in the gas sensor element 101 having the above-described configuration, foreign matter, poisonous substances, and the like are likely to accumulate in a portion of the gas introduction layer 200 that extends downward from the gas introduction opening 10. In other words, in the gas sensor element 101, foreign matter, poisonous substances, and the like are likely to accumulate in a portion of the gas introduction layer 200 “that extends toward the edge opposed to the edge closest to the gas introduction opening 10 out of the edges that surround the face of the element base 100 in which the gas introduction opening 10 is open”. Accordingly, it is possible to protect the gas sensor element 101 (particularly the element base 100) from adverse effects induced by foreign matter, poisonous substances, and the like.

Note that it is not essential that, on the face of the element base 100 in which the gas introduction opening 10 is open, the gas introduction layer 200 covers the entire gas introduction opening 10, and it is also not essential that the gas introduction layer 200 extends downward from the gas introduction opening 10. The gas sensor element 101 need only have a configuration in which the gas introduction layer 200 can reliably serve as a flow path through which the measurement target gas is guided from the protective layer 400 to the gas introduction opening 10, and the gas introduction layer 200 need only be in contact with the protective layer 400 and cover at least a portion of the gas introduction opening 10.

The gas introduction layer 200 has a porosity that is 30% or more and is higher by 5% or more than the porosity of the buffer layer 300. Due to the gas introduction layer 200 having a porosity of 30% or more, a necessary and sufficient amount of measurement target gas can be guided from the protective layer 400 to the gas introduction opening 10 through the gas introduction layer 200. Furthermore, the porosity of the gas introduction layer 200 is set to be higher by 5% or more than the porosity of the buffer layer 300 such that the measurement target gas selectively flows through the gas introduction layer 200 rather than the buffer layer 300.

Here, the inventors of the present invention carried out tests and found that it is desirable to set the porosity of the gas introduction layer 200 to 45% or more and 60% or less. Specifically, the inventors of the present invention carried out tests and found that, when gas introduction layers 200 having the same area (particularly the area of a face of the gas introduction layer 200 that is in contact with the face of the element base 100 in which the gas introduction opening 10 is open) are compared, a gas sensor element provided with a gas introduction layer 200 having a higher porosity exhibits more favorable responsiveness. In the gas sensor element 101, the gas introduction layer 200 having a porosity of 45% or more and 60% or less can necessarily and sufficiently serve as a flow path through which the measurement target gas is guided from the protective layer 400 to the gas introduction opening 10 of the element base 100.

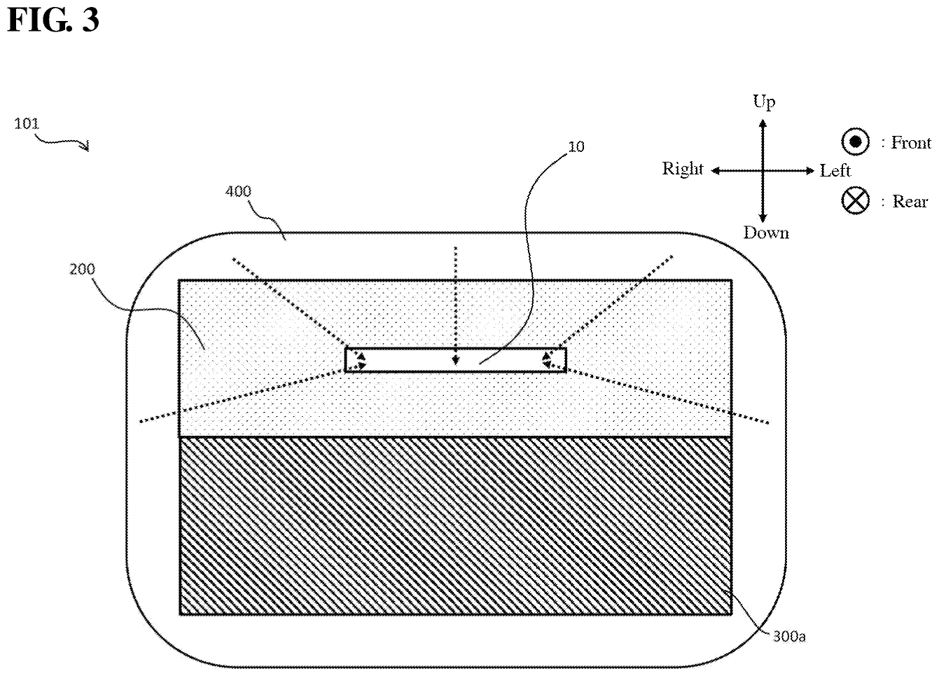

FIG. 3 is a diagram showing an example of a cross section of the gas sensor element 101 shown in FIG. 1 taken along line II-II and viewed in the direction of the arrows. In the example shown in FIG. 3, the area of the gas introduction layer 200, particularly the area of a face of the gas introduction layer 200 that is in contact with the face of the element base 100 (e.g., the leading end face of the element base 100) in which the gas introduction opening 10 is open, is about half of that of the leading end face of the element base 100. That is to say, as shown in FIG. 3, in the gas sensor element 101, about half of the face of the element base 100 in which the gas introduction opening 10 is open is in contact with the gas introduction layer 200, and the remainder is in contact with the buffer layer 300 (particularly the leading-end buffer layer 300a).

The buffer layer 300 (particularly the leading-end buffer layer 300a), which is in contact with about half of the face of the element base 100 in which the gas introduction opening 10 is open, prevents the protective layer 400 from peeling away from the face of the element base 100 in which the gas introduction opening 10 is open.

The gas introduction layer 200, which is in contact with about half of the face of the element base 100 in which the gas introduction opening 10 is open, is also in contact with the protective layer 400 at positions corresponding to the upper edge, a portion of the right edge, and a portion of the left edge of the face (leading end face) of the element base 100 in which the gas introduction opening 10 is open. Accordingly, as illustrated in FIG. 3, the measurement target gas can flow (can be guided) to the gas introduction opening 10 through the upper portion, the right portion, and the left portion of the gas introduction layer 200, which are in contact with the protective layer 400, in the gas sensor element 101. Thus, in the gas sensor element 101, a necessary and sufficient amount of the measurement target gas can be guided from the protective layer 400 to the gas introduction opening 10 through the gas introduction layer 200.

The inventors of the present invention carried out tests and obtained the following findings regarding the area of the gas introduction layer 200, specifically the area of a face of the gas introduction layer 200 that is in contact with the face (leading end face) of the element base 100 in which the gas introduction opening 10 is open. Specifically, the inventors of the present invention carried out tests and found that, in the element base 100, it is desirable to set the area of the gas introduction layer 200 to be 0.2 to 0.8 times as large as the area of the face of the element base 100 in which the gas introduction opening 10 is open.

In the gas sensor element 101, the gas introduction layer 200 having an area that is 0.2 to 0.8 times as large as the area of the face of the element base 100 in which the gas introduction opening 10 is open can necessarily and sufficiently serve as a flow path through which the measurement target gas is guided from the protective layer 400 to the gas introduction opening 10 of the element base 100.

### Features

As described above, the gas sensor element 101 according to this embodiment includes the element base 100 in which the measurement target gas is introduced into the target gas flow portion 7 (internal space) through the gas introduction opening 10 that is open in the surface of the element base 100, the protective layer 400, the buffer layer 300, and the gas introduction layer 200. The protective layer 400 covers at least the face of the element base 100 in which the gas introduction opening 10 is open, and is constituted by a single layer or a plurality of layers. The buffer layer 300 is disposed between the element base 100 and the protective layer 400 and has a porosity lower than that of the protective layer 400, and a portion of the buffer layer 300 is in contact with both the element base 100 and the protective layer 400 on the face of the element base 100 in which the gas introduction opening 10 is open. The gas introduction layer 200 is disposed between the element base 100 and the buffer layer 300, covers at least a portion of the gas introduction opening 10, and is in contact with the protective layer 400. In addition, the gas introduction layer 200 has a porosity that is 30% or more and is higher by 5% or more than the porosity of the buffer layer 300.

In this configuration, the buffer layer 300 prevents the protective layer 400 from peeling away from the element base 100, and the gas introduction layer 200 reliably serves as a flow path through which the measurement target gas is guided from the protective layer 400 to the gas introduction opening 10. In particular, due to the gas introduction layer 200 having a porosity of 30% or more, a necessary and sufficient amount of measurement target gas can be guided from the protective layer 400 to the gas introduction opening 10 through the gas introduction layer 200. Furthermore, the porosity of the gas introduction layer 200 is set to be higher by 5% or more than the porosity of the buffer layer 300, so that the measurement target gas selectively flows through the gas introduction layer 200 rather than the buffer layer 300. Accordingly, with the gas sensor element 101, a decrease in responsiveness can be prevented by the gas introduction layer 200 that reliably serves as a flow path through which the measurement target gas is guided from the protective layer 400 to the gas introduction opening 10 despite the protective layer 400 covering the gas introduction opening 10.

### MODIFIED EXAMPLES

Although an embodiment of the present invention has been described above, the foregoing description of the embodiment is to be construed in all respects as illustrative of the present invention. Various improvements and modifications may be made to the embodiment above. Omission, substitution, and/or addition of constituent elements in the embodiment above may be made as appropriate. Moreover, the shape and the dimensions of constituent elements in the embodiment above may be changed as appropriate in accordance with the mode of implementation. For example, changes such as the following can be made. Note that, in the following description, the same constituent elements as those in the embodiment above are given the same reference numerals, and description of aspects similar to those of the embodiment above will be omitted as appropriate. The modified examples described below can be combined as appropriate.

### (I) Area of Gas Introduction Layer

In the description above, the example in which the area of the gas introduction layer 200, particularly the area of a face of the gas introduction layer 200 that is in contact with the face (leading end face) of the element base 100 in which the gas introduction opening 10 is open, is about half of the area of the leading end face of the element base 100 is described with reference to FIG. 3. However, it is not essential that the area of the gas introduction layer 200 is about half of the area of the face of the element base 100 in which the gas introduction opening 10 is open.

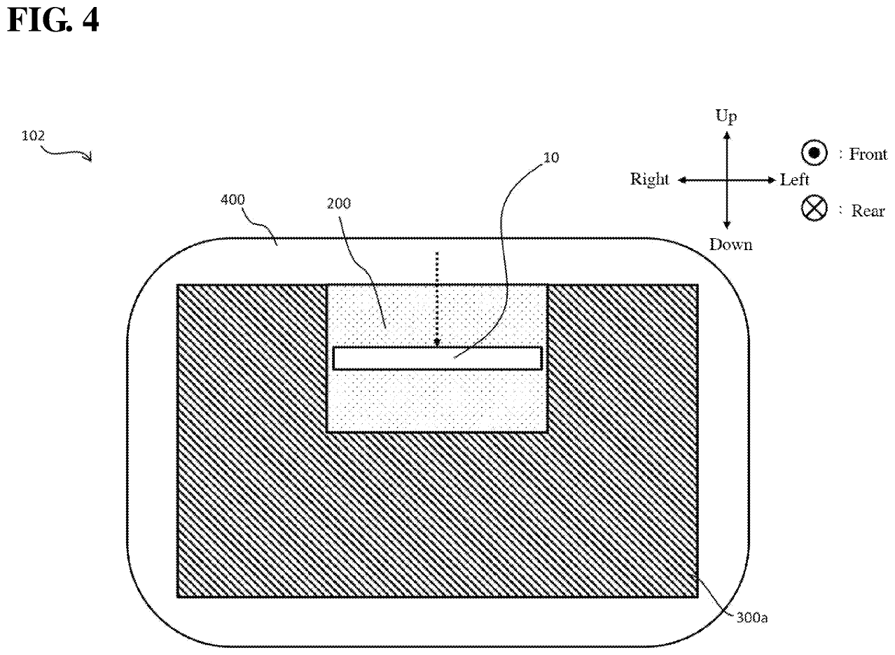

FIG. 4 is a diagram showing an example of a cross section of a gas sensor element 102 according to a modified example viewed in the direction of the arrows in the same manner as in FIG. 3. In the gas sensor element 102, the area of the gas introduction layer 200, particularly the area of a face of the gas introduction layer 200 that is in contact with the face (leading end face) of the element base 100 in which the gas introduction opening 10 is open, is 0.2 times as large as the area of the leading end face of the element base 100. That is to say, as shown in FIG. 4, in the gas sensor element 102, a portion corresponding to 20% of the whole area of the face of the element base 100 in which the gas introduction opening 10 is open is in contact with the gas introduction layer 200, and a portion corresponding to the remaining 80% is in contact with the buffer layer 300 (particularly the leading-end buffer layer 300a).

The buffer layer 300 (particularly the leading-end buffer layer 300a), which is in contact with the portion corresponding to 80% of the whole area of the face of the element base 100 in which the gas introduction opening 10 is open, prevents the protective layer 400 from peeling away from the face of the element base 100 in which the gas introduction opening 10 is open.

In particular, in the gas sensor element 102 illustrated in FIG. 4, the area of the buffer layer 300 (particularly the leading-end buffer layer 300a), which is in contact with both the protective layer 400 and the face of the element base 100 in which the gas introduction opening 10 is open, is larger than the area of the buffer layer 300 of the gas sensor element 101 illustrated in FIG. 3. Accordingly, the buffer layer 300 (particularly the leading-end buffer layer 300a) of the gas sensor element 102 prevents the protective layer 400 from peeling away from the face of the element base 100 in which the gas introduction opening 10 is open more effectively than the leading-end buffer layer 300a of the gas sensor element 101 does.

The gas introduction layer 200, which is in contact with the portion corresponding to 20% of the whole area of the face of the element base 100 in which the gas introduction opening 10 is open, is also in contact with the protective layer 400 at a position corresponding to the upper edge of the face of the element base 100 in which the gas introduction opening 10 is open. Accordingly, as illustrated in FIG. 4, the measurement target gas can flow (can be guided) to the gas introduction opening 10 through the upper portion of the gas introduction layer 200, which is in contact with the protective layer 400, in the gas sensor element 102.

Here, the amount of the measurement target gas that can flow (can be guided) from the protective layer 400 to the gas introduction opening 10 through the gas introduction layer 200 illustrated in FIG. 4 is smaller than the amount of the measurement target gas that can be guided from the protective layer 400 to the gas introduction opening 10 through the gas introduction layer 200 illustrated in FIG. 3.

The inventors of the present invention conducted numerous studies regarding to what extent the area of the gas introduction layer 200 that is in contact with the face of the element base 100 in which the gas introduction opening 10 is open should be secured in order to guide, from the protective layer 400 to the gas introduction opening 10, the measurement target gas in such an amount that is required to measure the NOₓ concentration. Specifically, the inventors of the present invention carried out tests and conducted numerous studies regarding “the area of the gas introduction layer 200” that is to be secured in order to guide, from the protective layer 400 to the gas introduction opening 10, the measurement target gas in such an amount that is required for concentration measurement. As a result, the inventors of the present invention found that, in order to guide, from the protective layer 400 to the gas introduction opening 10, the measurement target gas in such an amount that is required for concentration measurement, the area of the gas introduction layer 200, which is in contact with the face of the element base 100 in which the gas introduction opening 10 is open, should be 0.2 or more times as large as the area of the face of the element base 100 in which the gas introduction opening 10 is open. Due to the area of the face of the gas introduction layer 200 that is in contact with the face of the element base 100 in which the gas introduction opening 10 is open being 0.2 or more times as large as the area of the face of the element base 100 in which the gas introduction opening 10 is open, it is possible to guide the necessary amount of the measurement target gas from the protective layer 400 to the gas introduction opening 10.

As described above, in the gas sensor element 102, the area of the gas introduction layer 200 is 0.2 times as large as the area of the face of the element base 100 (the leading end face of the element base 100) in which the gas introduction opening 10 is open. Accordingly, the necessary amount of the measurement target gas can also be guided from the protective layer 400 to the gas introduction opening 10 through the gas introduction layer 200 illustrated in FIG. 4.

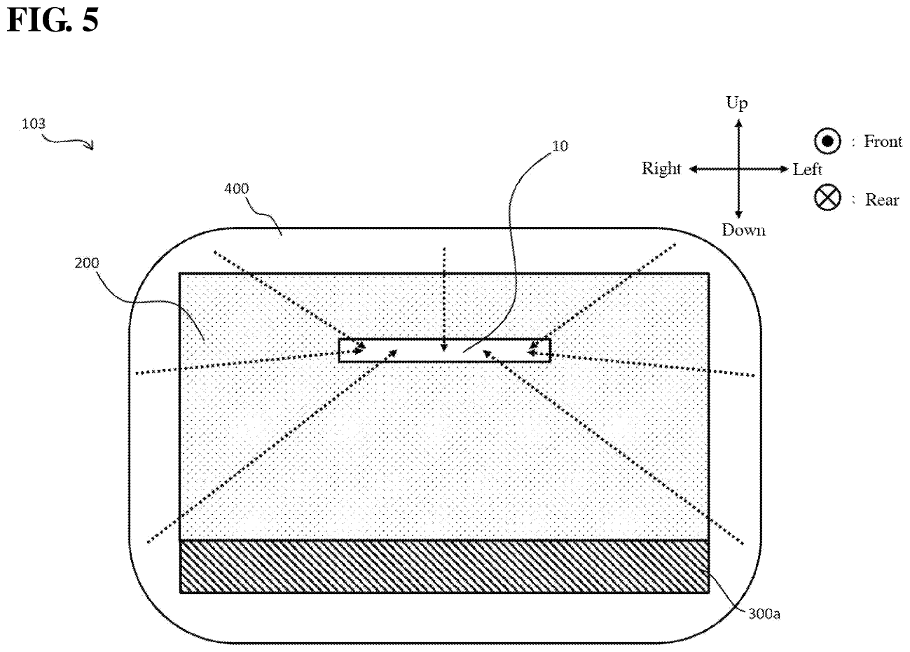

FIG. 5 is a diagram showing an example of a cross section of a gas sensor element 103 according to a modified example viewed in the direction of the arrows in the same manner as in FIG. 4. In this example, the area of the gas introduction layer is 0.8 times as large as the area of the leading end face. In the gas sensor element 103, the area of the gas introduction layer 200, particularly the area of a face of the gas introduction layer 200 that is in contact with the face (leading end face) of the element base 100 in which the gas introduction opening 10 is open, is 0.8 times as large as the area of the leading end face of the element base 100. That is to say, as shown in FIG. 5, in the gas sensor element 103, a portion corresponding to 80% of the whole area of the face of the element base 100 in which the gas introduction opening 10 is open is in contact with the gas introduction layer 200, and a portion corresponding to the remaining 20% is in contact with the buffer layer 300 (particularly the leading-end buffer layer 300a).

The buffer layer 300 (particularly the leading-end buffer layer 300a), which is in contact with the portion corresponding to 20% of the whole area of the face of the element base 100 in which the gas introduction opening 10 is open, prevents the protective layer 400 from peeling away from the face of the element base 100 in which the gas introduction opening 10 is open.

Here, in the gas sensor element 103 illustrated in FIG. 5, the area of the buffer layer 300 (particularly the leading-end buffer layer 300a), which is in contact with both the protective layer 400 and the face of the element base 100 in which the gas introduction opening 10 is open, is smaller than the area of the buffer layer 300 of the gas sensor element 101 illustrated in FIG. 3. Accordingly, the buffer layer 300 (particularly the leading-end buffer layer 300a) of the gas sensor element 103 prevents the protective layer 400 from peeling away from the face of the element base 100 in which the gas introduction opening 10 is open less effectively than the leading-end buffer layer 300a of the gas sensor element 101 does.

The inventors of the present invention conducted numerous studies regarding to what extent the area of the leading-end buffer layer 300a that is in contact with the face of the element base 100 in which the gas introduction opening 10 is open should be secured in order to prevent the protective layer 400 from peeling away from the face of the element base 100 in which the gas introduction opening 10 is open. In other words, the inventors of the present invention conducted numerous studies regarding to what extent the area of the gas introduction layer 200 that is in contact with the face of the element base 100 in which the gas introduction opening 10 is open should be reduced in order to prevent the protective layer 400 from peeling away from the face of the element base 100 in which the gas introduction opening 10 is open.

As a result, the inventors of the present invention found that, in order to prevent the protective layer 400 from peeling away from the face of the element base 100 in which the gas introduction opening 10 is open, the area of the leading-end buffer layer 300a, which is in contact with the face of the element base 100 in which the gas introduction opening 10 is open, should be 0.2 or more times as large as the area of the face of the element base 100 in which the gas introduction opening 10 is open. That is to say, the inventors of the present invention found that, in order to prevent the protective layer 400 from peeling away from the face of the element base 100 in which the gas introduction opening 10 is open, the area of the gas introduction layer 200, which is in contact with the face of the element base 100 in which the gas introduction opening 10 is open, should be 0.8 or less times as large as the area of the face of the element base 100 in which the gas introduction opening 10 is open. Due to the area of the face of the gas introduction layer 200 that is in contact with the face of the element base 100 in which the gas introduction opening 10 is open being 0.8 or less times as large as the area of the face of the element base 100 in which the gas introduction opening 10 is open, the leading-end buffer layer 300a can prevent the protective layer 400 from peeling away from the face of the element base 100 in which the gas introduction opening 10 is open.

The gas introduction layer 200, which is in contact with the portion corresponding to 80% of the whole area of the face of the element base 100 in which the gas introduction opening 10 is open, is also in contact with the protective layer 400 at positions corresponding to the upper edge, a portion of the right edge, and a portion of the left edge of the face of the element base 100 in which the gas introduction opening 10 is open. Accordingly, as illustrated in FIG. 5, the measurement target gas can flow (can be guided) to the gas introduction opening 10 through the upper portion, the right portion, and the left portion of the gas introduction layer 200, which are in contact with the protective layer 400, in the gas sensor element 103.

In particular, the amount of the measurement target gas that can flow (can be guided) from the protective layer 400 to the gas introduction opening 10 through the gas introduction layer 200 illustrated in FIG. 5 is larger than the amount of the measurement target gas that can be guided from the protective layer 400 to the gas introduction opening 10 through the gas introduction layer 200 illustrated in FIG. 3. Therefore, it is expected that the responsiveness of the gas sensor element 103 illustrated in FIG. 5 is further improved compared with the gas sensor element 101 illustrated in FIG. 3. The inventors of the present invention carried out tests for responsiveness and water resistance, which will be described later, and thus confirmed this tendency.

As described above, in the gas sensor element 103, the area of the gas introduction layer 200 is 0.8 times as large as the area of the face of the element base 100 (the leading end face of the element base 100) in which the gas introduction opening 10 is open. Accordingly, a sufficient amount of the measurement target gas can be guided from the protective layer 400 to the gas introduction opening 10 through the gas introduction layer 200 illustrated in FIG. 5 while the buffer layer 300 (leading-end buffer layer 300a) prevents the protective layer 400 from peeling away from the face of the element base 100 in which the gas introduction opening 10 is open.

As described with reference to FIGS. 4 and 5, it is desirable to set the area of the gas introduction layer 200 (i.e., the face of the gas introduction layer 200 that is in contact with the face of the element base 100 in which the gas introduction opening 10 is open) to be 0.2 to 0.8 times as large as the area of the face of the element base 100 in which the gas introduction opening 10.

With this configuration, the buffer layer 300 (leading-end buffer layer 300a) prevents the protective layer 400 from peeling away from the face of the element base 100 in which the gas introduction opening 10 is open, and a flow path through which the measurement target gas is guided from the protective layer 400 to the gas introduction opening 10 of the element base 100 can be necessarily and sufficiently secured.

(II) Extension of Portion of Gas Introduction Layer into Internal Cavity

In the description above, the example in which the gas introduction layer 200 is in contact with the protective layer 400 and covers at least a portion of the gas introduction opening 10 such that the gas introduction layer 200 can reliably serve as a flow path through which the measurement target gas is guided from the protective layer 400 to the gas 10 is described. However, another configuration may also be employed in which the gas introduction layer 200 is in contact with the protective layer 400 and covers at least a portion of the gas introduction opening 10, and in addition, a portion of the gas introduction layer 200 extends from the gas introduction opening 10 into the inside of the element base 100 (specifically, the target gas flow portion 7).

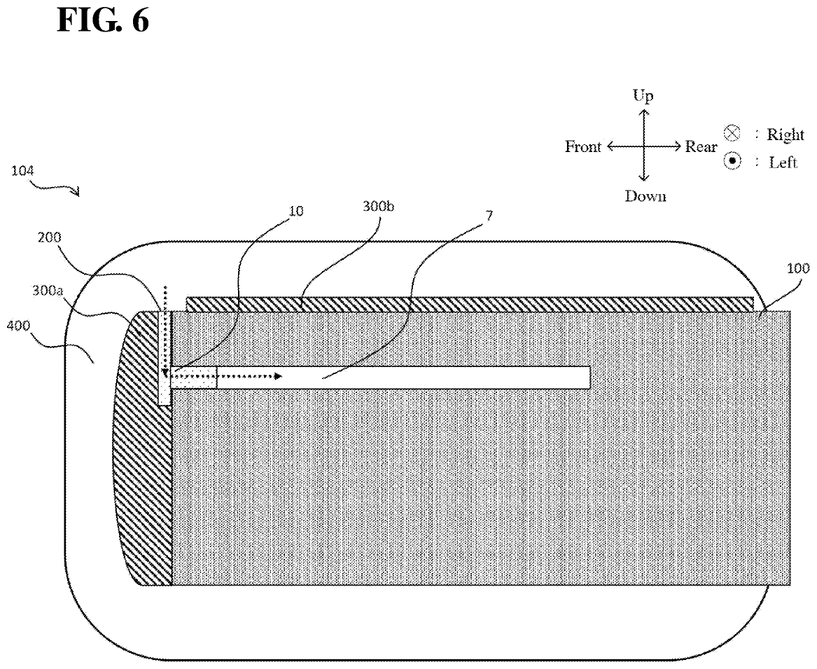

FIG. 6 is a schematic cross-sectional view schematically showing an example of the configuration of a gas sensor element 104 according to a modified example. As illustrated in FIG. 6, in the gas sensor element 104, a portion of the gas introduction layer 200 extends into the target gas flow portion 7. In the gas sensor element 104, a portion of the gas introduction layer 200 extends from the gas introduction opening 10 into the target gas flow portion 7. For example, a portion of the gas introduction layer 200 extends to a position near the first diffusion control portion 11.

### Features

In this modified example, a portion of the gas introduction layer 200 extends from the gas introduction opening 10 to the target gas flow portion 7 (the internal space of the element base 100). With this configuration, the gas introduction layer 200 can prevent foreign matter, poisonous substances, and the like from entering the target gas flow portion 7 via the gas introduction opening 10.

Note that, from the viewpoint of preventing a decrease in the responsiveness of the gas sensor element, it is not essential that a portion of the gas introduction layer 200 extends into the target gas flow portion 7 (the internal space of the element base 100). As described above, from the viewpoint of preventing a decrease in the responsiveness of the gas sensor element, it is sufficient that the gas introduction layer 200 covers at least a portion of the gas introduction opening 10.

### (III) Other Configurations

In the embodiment above, the laminate of the gas sensor element 101 is constituted by six solid electrolyte layers. However, the number of the solid electrolyte layers included in the laminate is not necessarily limited to such an example, and may be appropriately selected in accordance with the mode of implementation.

In the embodiment above, the internal space (i.e., the target gas flow portion 7) into which the measurement target gas is introduced is provided at a position defined by the first solid electrolyte layer 4, the spacer layer 5, and the second solid electrolyte layer 6. However, the positioning of the target gas flow portion 7 is not necessarily limited to such an example, and may be appropriately selected in accordance with the mode of implementation. The orientations of a first face, a second face, a first pump electrode, a second pump electrode, a first lead, and a second lead may be appropriately selected in accordance with the configurations of the laminate and the internal space. Also, it is not essential that the gas introduction opening 10 be provided in the upper portion of the face of the element base 100 in which the gas introduction opening 10 is open, and a position at which the gas introduction opening 10 is provided on the face of the element base 100 in which the gas introduction opening 10 is open may be appropriately selected. In the first place, it is not essential that the gas introduction opening 10 is provided in the face of the element base 100 in which the gas introduction opening 10 is open, and it is sufficient that at least one gas introduction opening 10 is provided at an appropriate position in the surface of the element base 100.

In the embodiment above, the target gas flow portion 7 is configured to have a three-cavity structure. However, the configuration of the target gas flow portion 7 does not have to be limited to such an example, and may be appropriately selected in accordance with the mode of implementation. In another example, the fourth diffusion control portion 18 and the third internal cavity 19 may be omitted, and accordingly, the target gas flow portion 7 may be configured to have a two-cavity structure. In this case, the measurement electrode 44 may be provided at a distance from the third diffusion control unit 16, on the upper face of the first solid electrolyte layer 4 adjacent to the second internal cavity 17. That is to say, the target gas flow portion 7 may include two chambers into or from which oxygen is pumped, or may contain only one. Also, it is not essential that the gas sensor element 101 includes one or more diffusion control portions.

In FIG. 2, the internal pump electrode 22 and the external pump electrode 23 are both exposed to a space. However, the state of being adjacent to a space does not have to be limited to such a configuration, and may be a state of being indirectly adjacent to a space via a coating or the like. As another example, the external pump electrode 23 may be covered by a protective member or the like.

In the embodiment above, the reference gas introduction space 43 is provided. However, the configuration of the gas sensor element 101 is not necessarily limited to such an example. In another example, the first solid electrolyte layer 4 may extend to the rear end of the gas sensor element 101, and the reference gas introduction space 43 may be omitted. In this case, the air introduction layer 48 may extend to the rear end of the gas sensor element 101.

In the embodiment above, the gas sensor element 101 is configured to measure the concentration of nitrogen oxide (NOₓ). However, the gas sensor element of the present invention is not necessarily limited to such a gas sensor element configured to measure the concentration of NOₓ. In another example, the gas sensor element of the present invention may be, for example, other gas sensor elements such as a gas sensor element configured to measure the concentration of oxygen. For example, it is possible to manufacture a gas sensor element for measuring oxygen concentration, by omitting the auxiliary pump cell and the measurement pump cell from the gas sensor element 101 according to the embodiment above, and disposing the reference electrode under the main pump electrode. In this case, the gas sensor element can measure the oxygen concentration in the measurement target gas by pumping out oxygen using the main pump cell.

### Examples (Test for Responsiveness and Water Resistance)

In order to verify effects (particularly responsiveness and water resistance) of the present invention, gas sensor elements according to the following examples and comparative examples were fabricated. However, the present invention is not limited to the following examples.

Gas sensor elements according to Examples 1 to 6 and Comparative Examples 4 to 6 were manufactured using the configuration shown in FIG. 1. Comparative Examples 1 to 3 were conventional gas sensor elements that did not include a gas introduction layer 200. In particular, Comparative Example 3 was a gas sensor element without a gas introduction layer 200 and a buffer layer 300. Comparative Examples 1 and 2 had the same structure as the gas sensor elements 101 described above (e.g., the gas sensor element 101 shown in FIG. 1), except for not being provided with the gas introduction layer 200. In other words, the difference between Comparative Examples 1 and 2 and Examples 1 to 6 and Comparative Examples 4 to 6 is whether or not the gas introduction layer 200 is provided. Comparative Example 3 had the same structure as the gas sensor elements 101 described above, except that neither the gas introduction layer 200 nor the buffer layer 300 was provided.

The porosities of the gas introduction layer 200, the buffer layer 300, and the protective layer 400 are values measured by analyzing SEM images obtained by observing the gas introduction layer 200, the buffer layer 300, and the protective layer 400 with a scanning electron microscope (SEM).

Among the gas sensor elements according to Examples 1 to 6 and Comparative Examples 4 to 6, which had the configuration shown in FIG. 1, the porosity of the gas introduction layer 200 included in the gas sensor element was set to 30% or more in Examples 1 to 6 and Comparative Examples 5 and 6. On the other hand, in Comparative Example 4, the porosity of the gas introduction layer 200 included in the gas sensor element was set to a value smaller than 30%.

Specifically, the porosity of the gas introduction layer 200 included in the gas sensor element was 31% in Example 1, 33% in Example 2, 42% in Example 3, 43% in Example 4, 48% in Example 5, and 55% in Example 6. In Comparative Examples 5 and 6, the porosity of the gas introduction layer 200 included in the gas sensor element was 31% and 50%, respectively. On the other hand, in Comparative Example 4, the porosity of the gas introduction layer 200 included in the gas sensor element was 28%.

Among the gas sensor elements according to Examples 1 to 6 and Comparative Examples 4 to 6, which had the configuration shown in FIG. 1, the porosity of the gas introduction layer 200 included in the gas sensor element was set to a value that is larger by 5% or more than the porosity of the buffer layer 300, in Examples 1 to 6 and Comparative Examples 4 and 6. On the other hand, in Comparative Example 5, a difference in porosity between the gas introduction layer 200 and the buffer layer 300 was set to less than 5′.

Specifically, compared with the porosity of the buffer layer 300, the porosity of the gas introduction layer 200 included in the gas sensor element was larger by 8% in Example 1, by 11% in Example 2, by 19% in Example 3, by 21% in Example 4, by 26% in Example 5, and by 33% in Example 6. In Comparative Examples 4 and 6, the porosity of the gas introduction layer 200 included in the gas sensor element was larger by 5% than the porosity of the buffer layer 300. On the other hand, in Comparative Example 5, the porosity of the gas introduction layer 200 included in the gas sensor element was larger by only 2% than the porosity of the buffer layer 300, and a difference in porosity between the gas introduction layer 200 and the buffer layer 300 was less than 5′.

Here, in Comparative Example 6, the porosity of the gas introduction layer 200 included in the gas sensor element was larger than or equal to 30%, and was a value larger by 5% or more than the porosity of the buffer layer 300, similarly to Examples 1 to 6. Note that, in Comparative Example 6, the porosity of the buffer layer 300 included in the gas sensor element was set to 30% or more. Specifically, the porosity of the buffer layer 300 included in the gas sensor element was 23% in Example 1, 22% in Examples 2 and 4 to 6, and 23% in Example 3, which were all less than 30%. On the other hand, in Comparative Example 6, the porosity of the buffer layer 300 included in the gas sensor element was 45%, which was 30% or more. Note that the porosity of the buffer layer 300 included in the gas sensor element was set to 21% in Comparative Example 1, 28% in Comparative Examples 2, 23% in Comparative Example 4, and 29% in Comparative Example 5.

A responsiveness test and a water resistance test as described below were performed on the above-described gas sensor elements according to the examples and comparative examples to evaluate the responsiveness and the water resistance.

Specifically, in the responsiveness test, a gas sensor that included the gas sensor element according to Comparative Example 1 was first attached to a pipe serving as an exhaust gas pipe of an automobile. Then, an electric current was applied to the heater 70 to raise the temperature to 800° C., and thus the gas sensor element according to Comparative Example 1 was heated. Next, a model gas obtained by mixing oxygen and NO with nitrogen serving as a base gas such that their concentrations were respectively a predetermined concentration and 70 ppm was used as a measurement target gas, and this measurement target gas was caused to flow through the pipe at a flow rate of 9 m/s. The above-described pump cells 21, 41, and 50 were operated to start the NOₓ concentration measurement by the gas sensor element according to Comparative Example 1. Then, once the value of the pump current Ip2 (a value corresponding to the NOₓ concentration in the measurement target gas) had become stable, the NOₓ concentration in the measurement target gas flowing through the pipe was changed to 70 ppm to 500 ppm, and then changes in the value of the pump current Ip2 over time were examined. The value of the pump current Ip2 just before the NOₓ concentration was changed was taken as 0%, the value of the pump current Ip2 that changed and become stable after the NOₓ concentration was changed was taken as 100%, and the length of time that elapsed between when the value of the pump current Ip2 exceeded 10% and when it exceeded 90% was taken as a response time (sec) of the NOₓ concentration detection. The shorter this response time is, the higher the responsiveness of the gas sensor element is. Also, for the gas sensor elements according to Examples 1 to 6 and Comparative Examples 2 to 6, the response time was measured in the same manner. The measurement of the response time was performed a plurality of times on each of the gas sensors according to Examples 1 to 6 and Comparative Examples 1 to 6, and the average values were taken as the response times of the gas sensor elements according to Examples 1 to 6 and Comparative Examples 1 to 6.

In the water resistance test, water was dripped onto the protective layer 400 at a constant time interval shorter than or equal to 500 msec while each of the gas sensor elements according to Examples 1 to 6 and Comparative Examples 1 to 6 was heated by the heater 70 under the same heating conditions as those for the actual operation of the gas sensor element 101. The total amounts of water dripped until the gas sensor elements according to Examples 1 to 6 and Comparative Examples 1 to 6 broke (water-induced breakage occurred) were determined as limit water amounts, and the degree of the water resistance was evaluated according to the magnitude of the limit water amount. That is to say, in the water resistance test, the limit water amount was used as an index value for the water resistance. The larger the limit water amount is, the better the water resistance is.

Table 1 below shows the results of the evaluations of the responsiveness and the water resistance. In Table 1, “Layer number” of “Protective layer” indicates the number of layers constituting the protective layer 400 included in each of the gas sensor elements according to Examples 1 to 6 and Comparative Examples 1 to 6, and “Porosity” of “Protective layer” indicates the porosity of the protective layer 400. “Presence” of “Buffer layer” indicates whether or not each of the gas sensor elements according to Examples 1 to 6 and Comparative Examples 1 to 6 included the buffer layer 300, and “Porosity” of “Buffer layer” indicates the porosity of the buffer layer 300 in the case where the gas sensor element included the buffer layer 300. “Presence” of “Gas introduction layer” indicates whether or not each of the gas sensor elements according to Examples 1 to 6 and Comparative Examples 1 to 6 included the gas introduction layer 200, and “Porosity” of “Gas introduction layer” indicates the porosity of the gas introduction layer 200 in the case where the gas sensor element included the gas introduction layer 200. “Cross-sectional area ratio” of “Gas introduction layer” indicates the area ratio between the gas introduction layer 200 and the face of the element base 100 in which the gas introduction opening 10 is open in each of Examples 1 to 6 and Comparative Examples 1 to 6 in the case where the gas sensor element included the gas introduction layer 200. In other words, “Cross-sectional area ratio” indicates the proportion or ratio of the area of the face of the gas introduction layer 200 that is in contact with the face of the element base 100 in which the gas introduction opening 10 is open to the area of the face of the element base 100 in which the gas introduction opening 10 is open.

In Table 1, “Responsiveness” of “Evaluation results” indicates the results of the above-described responsiveness test on the gas sensor elements according to Examples 1 to 6 and Comparative Examples 1 to 6. “Responsiveness” is indicated as a relative evaluation based on the results (i.e., response time) of the above-described responsiveness test on the gas sensor element according to Comparative Example 1. That is to say, the results (response times) of the above-described responsiveness test on the gas sensor elements according to Examples 1 to 6 and Comparative Examples 2 to 6 were compared with the response time of the gas sensor element according to Comparative Example 1, and thus “Responsiveness” of each gas sensor element was evaluated. Specifically, the response time of the gas sensor element according to Comparative Example 1 was used as the standard time, and if the response time of the gas sensor element was within a range of the base time ±10% in Examples 1 to 6 and Comparative Examples 2 to 6, “Responsiveness” was evaluated as “Poor”. If the response time was 70% or more of the base time and less than 90% of the base time, “Responsiveness” was evaluated as “Good”. If the response time was less than 70% of the base time, “Responsiveness” was evaluated as “Excellent”.

In Table 1, “Water resistance” of “Evaluation results” indicates the results of the above-described water resistance test on the gas sensor elements according to Examples 1 to 6 and Comparative Examples 1 to 6. Specifically, if the result (limit water amount) of the above-described water resistance test was “5 μm or more”, “Water resistance” was evaluated as “Good”, and if the result was less than “5 μm”, “Water resistance” was evaluated as “Poor”.

TABLE 1

| | | | | | | | Gas introduction layer | | | | |
|---|---|---|---|---|---|---|---|---|---|---|---|
| | | | Protective layer | | | | | | Cross- | Evaluation results | |
| | | | Layer | | Buffer layer | | | | sectional | | Water |
| | | | number | Porosity | Presence | Porosity | Presence | Porosity | area ratio | Responsiveness | resistance |
| Prior | Comp. | 1 | 1 | 50% | Yes | 21% | No | — | — | Standard | Good |
| Art | Ex. | | | | | | | | | | |
| Prior | Comp. | 2 | 1 | 51% | Yes | 28% | No | — | — | Poor | Good |
| Art | Ex. | | | | | | | | | | |
| Prior | Comp. | 3 | 1 | 51% | Yes | — | No | — | — | Poor | Poor |
| Art | Ex. | | | | | | | | | | |
| | Comp. | 4 | 1 | 49% | Yes | 23% | Yes | 28% | 0.65 | Poor | Good |
| | Ex. | | | | | | | | | | |
| | Comp. | 5 | 1 | 59% | Yes | 29% | Yes | 31% | 0.63 | Poor | Poor |
| | Ex. | | | | | | | | | | |
| | Ex. | 1 | 1 | 49% | Yes | 23% | Yes | 31% | 0.25 | Good | Good |
| | Ex. | 2 | 1 | 50% | Yes | 22% | Yes | 33% | 0.73 | Excellent | Good |
| | Ex. | 3 | 1 | 49% | Yes | 23% | Yes | 42% | 0.69 | Excellent | Good |
| | Ex. | 4 | 1 | 50% | Yes | 22% | Yes | 43% | 0.15 | Good | Good |
| | Ex. | 5 | 1 | 50% | Yes | 22% | Yes | 48% | 0.25 | Excellent | Good |
| | Ex. | 6 | 1 | 50% | Yes | 22% | Yes | 55% | 0.25 | Excellent | Good |
| | Comp. | 6 | 1 | 60% | Yes | 45% | Yes | 50% | 0.22 | Good | Poor |
| | Ex. | | | | | | | | | | |

As is clear from the evaluation results in Table 1, “Responsiveness” of Examples 1 to 6 was better than that of Comparative Examples 1 to 5. It was found from these results that providing the gas introduction layer 200 having a porosity that is 30% or more and is higher by 5% or more than the porosity of the buffer layer 300 makes it possible to improve “Responsiveness” of the gas sensor element.

That is to say, “Responsiveness” of Comparative Examples 1 to 3 provided with no gas introduction layer 200 was “Poor”. On the other hand, “Responsiveness” of Examples 1 to 6 was better than “Responsiveness” of Comparative Examples 1 to 3 and was evaluated as “Good” or “Excellent”. Accordingly, from the viewpoint of “Responsiveness” of the gas sensor element, it is desirable to provide the gas introduction layer 200.

“Responsiveness” of Comparative Example 4 in which the gas introduction layer 200 had a porosity that was higher by 5% or more than the porosity of the buffer layer 300 but was less than 30% (specifically, 28%) was “Poor”. On the other hand, “Responsiveness” of Examples 1 to 6 was better than “Responsiveness” of Comparative Example 4 and was evaluated as “Good” or “Excellent”. Accordingly, from the viewpoint of “Responsiveness” of the gas sensor element, it is desirable to set the porosity of the gas introduction layer 200 to 30% or more.

Furthermore, “Responsiveness” of Comparative Example 5 in which the gas introduction layer 200 had a porosity that was 30% or more but was higher by only less than 5% (specifically, 2%) than the porosity of the buffer layer 300 was “Poor”. On the other hand, “Responsiveness” of Examples 1 to 6 was better than “Responsiveness” of Comparative Example 5 and was evaluated as “Good” or “Excellent”. Accordingly, from the viewpoint of “Responsiveness” of the gas sensor element, it is desirable to set the porosity of the gas introduction layer 200 to be higher by 5% or more than the porosity of the buffer layer 300.

Here, “Responsiveness” of Examples 2, 3, 5, and 6 out of Examples 1 to 6 was better than “Responsiveness” of Examples 1 and 4. It is conceived that “Porosity” and “Cross-sectional area ratio” of the gas introduction layer 200 contribute to such an improvement in “Responsiveness”.

Specifically, although “Cross-sectional area ratio” of Examples 1, 5, and 6 was “0.25”, Example 1 in which “Responsiveness” was “Good” had “Porosity” of 31%, Examples 5 and 6 in which “Responsiveness” was “Excellent” had “Porosity” of “48%” and “55%”, respectively. That is to say, even if gas introduction layers 200 have similar “Cross-sectional area ratio”, the higher “Porosity” of the gas introduction layer 200 is, the better the responsiveness of the gas sensor element is. In particular, as in Examples 5 and 6, it is desirable to set “Porosity” of the gas introduction layer 200 to 45% or more. Note that, if “Porosity” of the gas introduction layer 200 is excessively high, the porosity of the buffer layer 300 has to be increased correspondingly, and therefore, it is desirable that “Porosity” of the gas introduction layer 200 be 60% or less. That is to say, it is desirable to set “Porosity” of the gas introduction layer 200 to 45% or more and 60% or less.

Out of Examples 2 to 4, Example 4 had the highest “Porosity” of the gas introduction layer 200. However, Examples 2 and 3 respectively had “Cross-sectional area ratio” of “0.73” and “0.69”, which were within a range of 0.2 to 0.8, whereas Example 4 had “Cross-sectional area ratio” of “0.15”, which was less than 0.2. Furthermore, “Responsiveness” of Example 4 was “Good”, whereas “Responsiveness” of Examples 2 and 3 was “Excellent”. Accordingly, Table 1 shows that setting “Cross-sectional area ratio” of the gas introduction layer 200 to be within a range of 0.2 to 0.8 makes it possible to improve the responsiveness of the gas sensor element.

In Comparative Example 6, “Responsiveness” was “Good”, but “Water resistance” was “Poor”. It is conceived that the gas sensor element according to Comparative Example 6 included the gas introduction layer 200 having a porosity that was 30% or more and was higher by 5% or more than the porosity of the buffer layer 300 similarly to the gas sensor elements according to Examples 1 to 6, and thus had a favorable “Responsiveness”. However, unlike Examples 1 to 6, the buffer layer 300 had a porosity of 30% or more (specifically, 45%) in the gas sensor element according to Comparative Example 6. Furthermore, in Comparative Example 6, “Water resistance” was “Poor”. It is conceived that the reason for this is that a buffer layer 300 having a porosity of 30% or more does not function as the buffer layer 300 (the gas sensor element is susceptible to damage). Accordingly, from the viewpoint of “Water resistance” of the gas sensor element, it is desirable to set the porosity of the buffer layer 300 to less than 30%.

From these results, it was verified that, with the above-described embodiment and modified examples, it is possible to provide a gas sensor element capable of preventing a decrease in the responsiveness despite the protective layer covering the gas introduction opening.

That is to say, it was found that providing the gas introduction layer 200 having a porosity that is 30% or more and is higher by 5% or more than the porosity of the buffer layer 300 makes it possible to improve “Responsiveness” of the gas sensor element. Also, it was found that, in view of “Water resistance” in addition to “Responsiveness”, it is desirable to set the porosity of the buffer layer 300 to less than 30% in addition to setting the porosity of the gas introduction layer 200 to be 30% or more and higher by 5% or more than the porosity of the buffer layer 300.

### LIST OF REFERENCE NUMERALS

1, 102, 103, 104 Sensor element
100 Element base
7 Target gas flow portion (internal space)
10 Gas introduction opening
200 Gas introduction layer
300 Buffer layer
400 Protective layer

What is claimed is:

1. A gas sensor element comprising:
an element base having a surface in which a gas introduction opening is open, a measurement target gas being introduced into an internal space through the gas introduction opening;
a protective layer that covers at least a face of the element base in which the gas introduction opening is open;
a buffer layer that is disposed between the element base and the protective layer,
a portion of the buffer layer being in contact with both the element base and the protective layer on the face of the element base in which the gas introduction opening is open, the buffer layer having a porosity lower than a porosity of the protective layer; and
a gas introduction layer that is disposed between the element base and the buffer layer,
the gas introduction layer covering at least a portion of the gas introduction opening, being in contact with the protective layer, and having a porosity that is 30% or more and is higher by 5% or more than a porosity of the buffer layer.

2. The gas sensor element according to claim 1,
wherein the gas introduction layer has an area that is 0.2 to 0.8 times as large as an area of the face of the element base in which the gas introduction opening is open.

3. The gas sensor element according to claim 1,
wherein the gas introduction layer has a porosity of 45% or more and 60% or less.

4. The gas sensor element according to claim 1,
wherein the gas introduction layer is in contact with the protective layer at at least an edge closest to the gas introduction opening out of edges that surround the face of the element base in which the gas introduction opening is open.

5. The gas sensor element according to claim 1,
wherein the gas introduction layer covers the entire gas introduction opening on the face of the element base in which the gas introduction opening is open, and further extends from the gas introduction opening toward an edge opposed to an edge closest to the gas introduction opening out of edges that surround the face of the element base in which the gas introduction opening is open.

6. The gas sensor element according to claim 1,
wherein a portion of the gas introduction layer extends from the gas introduction opening into the internal space.
